(19) United States
(12) Patent Application Publication
(10) Pub. No.: US 2025/0241353 A1
(43) Pub. Date: Jul. 31, 2025

(54) PLATFORM KIT FOR IMPROVING AN EDIBLE INK PRINTING DEVICE

(71) Applicant: Nikki Bowman, Denver, NC (US)

(72) Inventor: Nikki Bowman, Denver, NC (US)

(21) Appl. No.: 19/034,756

(22) Filed: Jan. 23, 2025

Related U.S. Application Data
(60) Provisional application No. 63/626,593, filed on Jan. 30, 2024.

(51) Int. Cl. A23P 20/15; B41J 3/407

(52) U.S. Cl. CPC A23P 20/15; B41J 3/407

(57) ABSTRACT

A set of accessories for improving an edible ink printer having a first embodiment and second embodiment. Included within the first embodiment is a first implementation being a plurality, preferably four (4) cylindrical feet (including extensions), each cylindrical foot dimensioned to be positioned underneath an edible printer (or over the existing feet of an edible printer). A second implementation is a carousel connecting peg to interpose additional space between an edible ink printer and a rotating carousel platter of said edible ink printer. A third implementation is an improved tongue. A fourth implementation is a corresponding tongue extension for receiving the tongue. A fifth implementation is a multi-pronged carousel height extender.

### CROSS REFERENCE TO RELATED APPLICATION

This application claims priority through (1) U.S. Provisional Application 63/297,560 titled FOOD POSITIONING TRAY ACCESSORY FOR EDIBLE INK PRINTING DEVICE, filed Jan. 7, 2022; (2) U.S. Regular application Ser. No. 17/848,511 titled FOOD POSITIONING TRAY ACCESSORY FOR EDIBLE INK PRINTING DEVICE, filed Jun. 24, 2022; (3) U.S. Provisional Patent Application 63/626,593 HEIGHT ACCESSORY KIT FOR AN EDIBLE INK PRINTING DEVICE filed Jan. 30, 2024; and (4) U.S. Provisional Patent Application 63/688,495 titled TRAY AND CAROUSEL PLATTER FOR AN EDIBLE INK PRINTER DEVICE filed Aug. 29, 2024.

### TECHNICAL FIELD

The invention comprises several accessories for use with an edible ink printer to enable the printing of edible ink on a variety of sizes and shapes of baked and/or edible goods.

### BACKGROUND

The edible ink printer 100 as seen in FIG. 1 is a consumer device and baking appliance which prints a customized image onto a food item, for example a cookie, using edible ink. Two such edible ink printers are the Primera Eddie® and Freddie®. The major parts of an edible ink printer are designed for precise, food-safe operation. Key components include a main structure 101 having a printer body which holds the internal mechanisms, print head, electronics, and other essential components and a carousel mechanism 102 comprised of a carousel base. The carousel mechanism 102 is a platform that rotates edible items (e.g., cookies, macarons) during printing and a carousel platter 103 which is a detachable platter designed to hold various food sizes securely while allowing for even rotation. An O-ring ensures smooth and consistent rotation of the carousel platter 103. The print head assembly is the mechanism that deposits edible ink onto the surface of the food item. An edible ink cartridge holder holds the FDA-approved edible ink cartridges in place. An encoder strip tracks the position of the print head for precise movements. The encoder mount and belt tensioner keeps the belts tight and aligned, ensuring accurate rotation and printing. A maintenance station cleans and maintains the print head to prevent clogs and ensure consistent ink flow. A cover protects the internal components from dust and debris while allowing users to view the printing process. A control and power system provides the necessary power for the printer's operation, with international plug options. A control panel/software interface enables users to manage print settings and designs. The flex cable and idler pulley system facilitates communication between the printer's electronic systems and its moving components.

Typically, the printer has two modes of operation: using a rotating carousel platter to automatically hold and reposition multiple food items for individual prints or using a so-called “manual feed” system to print on one food item at a time. The rotating carousel, while being a more efficient mode of operation, is limited to food items of a limited range of sizes and shapes, due to the placement of, inter alia, protruding pegs 104 used for positioning and alignment of said food items, and further due to the size and shape of cut-out slots 105 for admitting the mechanism which lifts each food item out of the carousel platter and repositions it for printing. The manual feed mode, while more time-consuming and labor-intensive, admits a larger variety of food item shapes and sizes. In the rotating carousel mode of operation, a carousel platter which can hold up to 12 food items is rotated to a specific angle, allowing the printer to access a specific position and associated food item. The food item is then lifted away from the platter, repositioned under the printer head, applied with a desired image in edible ink, and re-placed on the platter. The printed food items can be swapped out with unprinted food items manually by a user as the platter rotates. In order to achieve consistent positioning of a given image on a food item, the food item must have a size and shape such that it can be consistently aligned using the protruding positioning pegs. This generally limits the food item dimensions to certain shapes and sizes. What is desired is a platform kit comprised of a plurality of components that can be positioned on and adjacent to a standard edible ink printer in order to facilitate the printing of edible ink on a wider variety of sizes and types of edible products such as cookies and baked goods.

### SUMMARY

The invention is a platform kit comprised of two embodiments, a first being a height accessory kit for use with an edible ink printer, the second embodiment being a tray and carousel platter with associated pegs having dimensions for printing on a greater variety of sizes of food products. Each embodiment is comprised of several components, referred to herein as implementations. In combination, the two embodiments with their implementations comprise a platform kit or a system for improving an edible ink printer.

When the height kit is installed with, in and on the edible ink printer 100, it allows the user to print on baked and/or edible goods having a thickness greater than that accommodated by a stock edible printer. The first embodiment of the invention comprises the following components, which are referred to as implementations: the first implementation is a plurality, preferably four (4) cylindrical feet, each such cylindrical foot positioned underneath an edible printer coaxially aligned and inserted over an existing foot of an edible printer; the second implementation being a plurality of carousel alignment coupling pegs operable to couple the edible ink printer main structure to the carousel mechanism of said edible ink printer; the third implementation being at least one improved tongue comprising a horizontal plane member onto which an edible food product is positioned; the fourth implementation being a corresponding tongue extension for extending the receiving arm of the edible ink printer, a distal end of the tongue extension coupled to the receiving arm and proximate end of the tongue extension for receiving the tongue; and the fifth implementation being a multi-pronged carousel height extender configured to be positioned between the edible ink printer carousel mechanism motor base and a carousel platter, the multi-pronged carousel height extender preferably having a horizontal planar upper and lower surface in a cross shape with four (4) vertical prongs extending from the upper surface.

The second embodiment of the invention is an improved tray and carousel platter with associated pegs for use with an edible ink printer and being positioned on the carousel mechanism motor base. When the improved tray is used with the edible ink printer, it allows the user to print on baked and/or edible goods having a size or shape different or greater than that accommodated by a stock edible ink printer.

The second embodiment of the invention having a sixth implementation is a carousel platter that allows for printing of items up to 4.724″×4.724″×¾″ due to the location of alignment pegs. A conventional platter on an edible ink printer limits the size to 4.724″×3.5″×¾″ due to the location and height of the alignment pegs. The second embodiment is related to co-owned and co-pending U.S. patent application Ser. No. 17/848,511 filed Nov. 4, 2023 which discloses an accessory tray apparatus for use with a rotating carousel platter and edible ink printer, said apparatus comprising a thin rectangular tray defining an upper surface parallel with the upper surface of said carousel platter, a lower surface parallel with and oriented opposite to said upper surface, an outer edge between said upper and lower surfaces and oriented such that it is facing outward with respect to the center of said platter, an inner edge between said upper and lower surfaces oriented opposite said outer edge, and lateral edges between said upper and lower surfaces and between said inner and outer edges, said tray further comprising a placement tab; said placement tab further comprising a trapezoidal tab extending from the inner edge of said tray toward the center of said platter, said placement tab being dimensioned to fit laterally in the space defined by positioning pegs protruding from the upper surface of said carousel platter such that said tray, once placed on said platter and pushed toward the center of said platter to the furthest extent, is in contact with two positioning pegs, one on each side of said placement tab, the movement of said tray being thereby laterally constrained.

The second embodiment of the invention is designed to allow users to print thicker items using an edible ink printer 100. The carousel platter comprising the second embodiment of the invention includes the pegs that are located circumferentially closer toward the center of the carousel platter. Such carousel platter has at most 6 open slots for receiving a retrieval tongue to allow printing on items that are up to 4.724″×4.724×¾″ thick. Using the carousel platter disclosed herein with the first embodiment hereof, a user can print on items that are up to 4.724″×4.724″×2″ thick. Also, for more accurate printing, and placement with the claimed carousel platter coupled with SXL trays claimed herein and the first embodiment hereof, a user can print on items up to 4.724″×4.724″×1.8″ thick. Printing items with these dimensions was not possible with the conventional carousel platter due to peg placement. By locating the pegs as shown in the figures herein, the carousel platter is able to hold larger and thicker items for printing.

The second embodiment of the invention further comprises the use of round pegs which are more stable over conventional pegs. These pegs are positioned so as not to interfere with the larger items that are to be printed. Furthermore, the pegs are moved circumferentially toward the center of the carousel platter and further apart over the conventional placement so as to remove the obstacles and open up the platter to hold larger items for printing.

To those skilled in the art to which this invention relates, many changes in construction and widely differing embodiments and applications of the invention will suggest themselves without departing from the scope of the invention as defined herein. The disclosures and the descriptions herein are purely illustrative and are not intended to be in any sense limiting.

### BRIEF DESCRIPTION OF THE DRAWINGS

For a better understanding of the invention including the features, advantages and specific embodiments, reference is made to the following detailed description along with accompanying Figures, wherein:

FIG. 1 is a perspective view of an edible ink printer (prior art);

FIG. 2 is a view of a cylindrical foot extension operable to interpose space between an edible ink printer and a table or other structure on which the edible ink printer is located;

FIG. 3 is a side view of two of the four cylindrical feet extensions positioned underneath an edible ink printer;

FIG. 4 is a perspective view of an edible ink printer with the cylindrical feet extensions and carousel alignment coupling pegs installed thereon;

FIG. 5A is a perspective view of a first aspect of an improved tongue positioned on a tongue extension being a third implementation of the invention;

FIG. 5B is a perspective view of the first aspect of the improved tongue being a third implementation of the invention;

FIG. 5C is a perspective view of the second aspect of the improved tongue being a third implementation of the invention;

FIG. 6 is a front view of a third aspect of an improved tongue being a third implementation of the invention;

FIG. 7A is a view of the third aspect of the improved tongue being in an inverted position also being a third implementation of the invention;

FIG. 7B is a view of a tongue extension for extending the receiving arm of the edible ink printer for use with the third aspect of the improved tongue;

FIG. 8A is a side view of a tongue extension for extending the receiving arm of the edible ink printer for use with the second aspect of the improved tongue;

FIG. 8B is a top view of the tongue first aspect of third implementation of the improved tongue positioned on the second aspect of the tongue extension;

FIG. 9 is a view of a fifth implementation of the invention comprising a multi-pronged carousel height extender;

FIG. 10 is a view of the multi-pronged carousel height extender positioned on a carousel mechanism adjacent to the main housing of an edible ink printer;

FIG. 11 is a view of a second embodiment being a sixth implementation of the invention comprised of an improved carousel platter having 6 tongue slots;

FIG. 12 is a view of a second embodiment being a seventh implementation of the invention comprised of another improved carousel platter having 12 tongue slots and including three different trays thereon; and

FIG. 13 is another view of the second embodiment being a sixth implementation of the invention comprised of the improved carousel platter having 6 tongue slots and including two trays thereon.

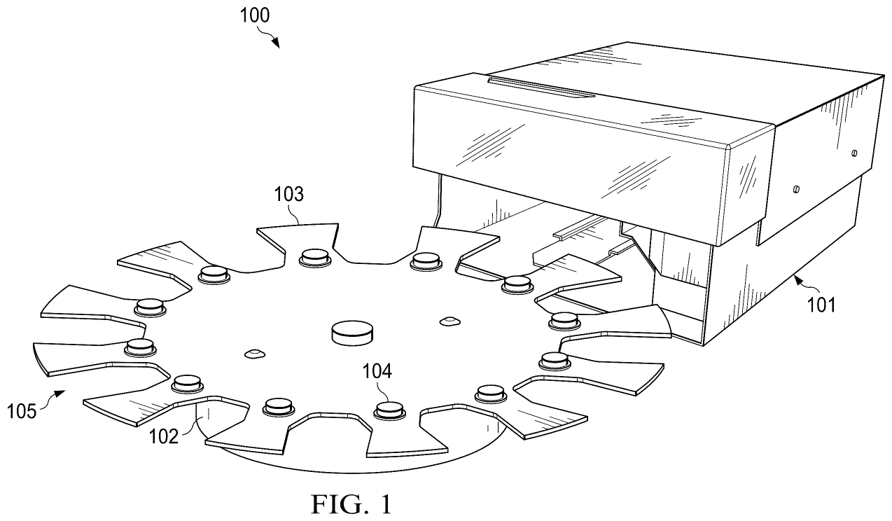

### DETAILED DESCRIPTION

While the making and using of the disclosed embodiments of the invention is discussed in detail below, it should be appreciated that the invention provides many applicable inventive concepts which can be embodied in a wide variety of specific contexts. Some features of the preferred embodiments shown and discussed may be simplified or exaggerated for illustrating the principles of the invention.

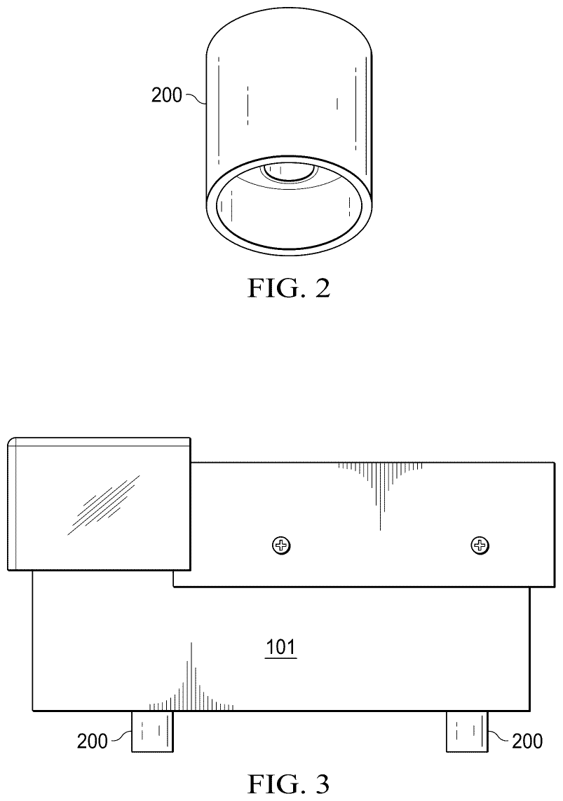

A first embodiment of the invention is a height accessory kit for use with an edible ink printer. The first embodiment of the invention is comprised of several components, referred to as implementations, that together comprise the first embodiment of the invention. A first implementation of the invention comprises four (4) cylindrical feet extensions. A cylindrical foot extension 200 is seen in FIG. 2. Each of a plurality of cylindrical feet 200 is positioned underneath a main structure 101 of an edible ink printer (or over the existing feet of an edible printer) and as seen in FIG. 3.

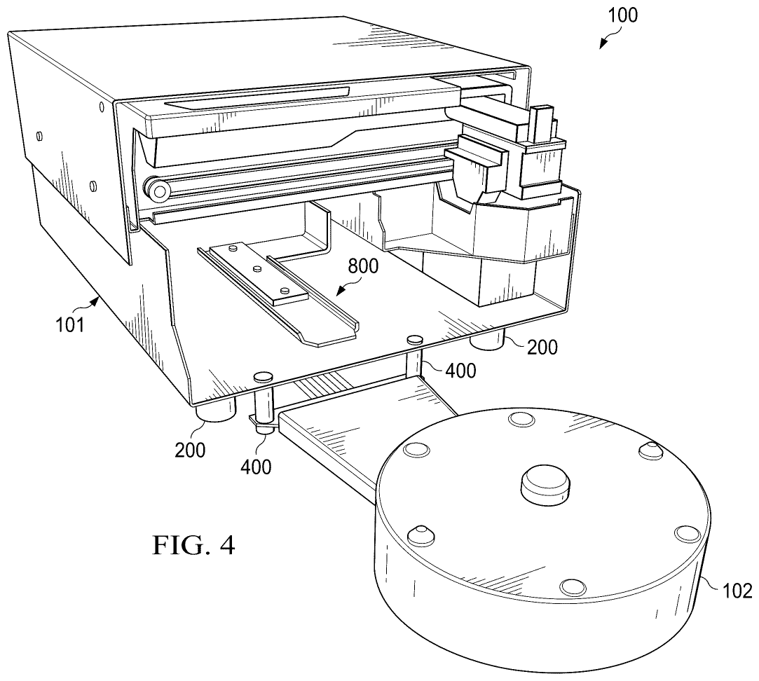

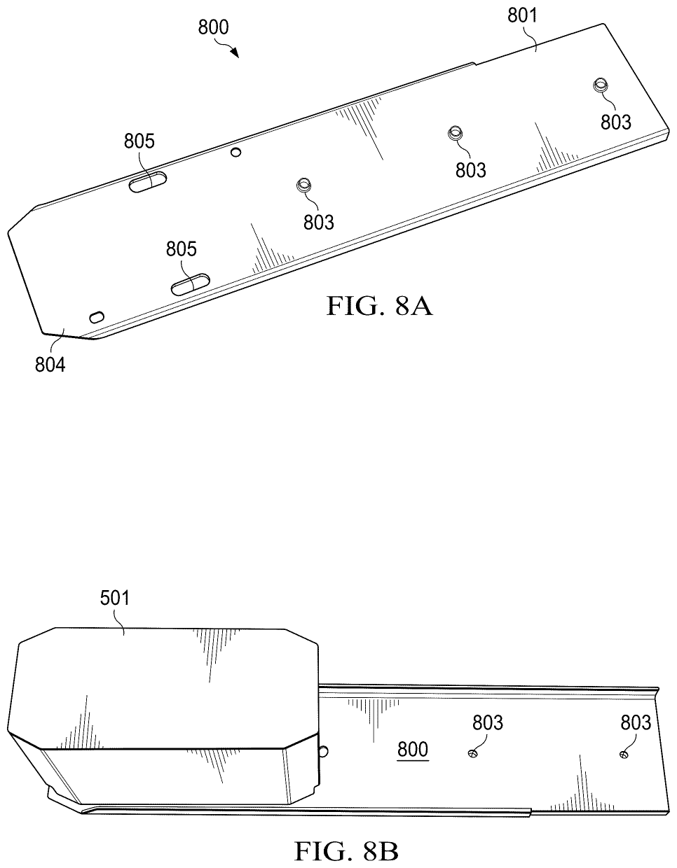

Referring to FIG. 4, there is a perspective view of an edible ink printer 100 with a main structure 101, carousel mechanism 102, showing cylindrical feet extensions 200 and carousel alignment coupling pegs 400 installed thereon. Also seen is tongue extension 800 (described in FIG. 8A). Carousel alignment coupling pegs 400 are cylindrical members that interpose lateral space between the main structure 101 and carousel mechanism 102 of edible ink printer 100. By raising the height of a main structure 101 using cylindrical feet extensions 200, one is able to print a greater variety of sizes of food items that have been placed on carousel mechanism 102. When raising the main structure 101, it is preferable to maintain the relative height of the main structure 101 in relation to the carousel mechanism 102. The carousel alignment coupling pegs 400 are used to couple the main structure 101 and carousel mechanism 102 of edible ink printer 100 to achieve this objective.

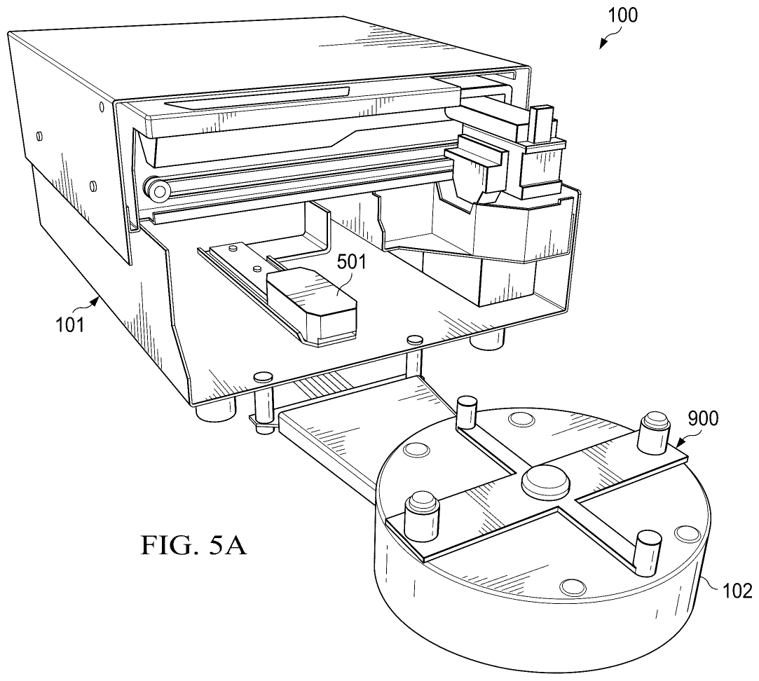

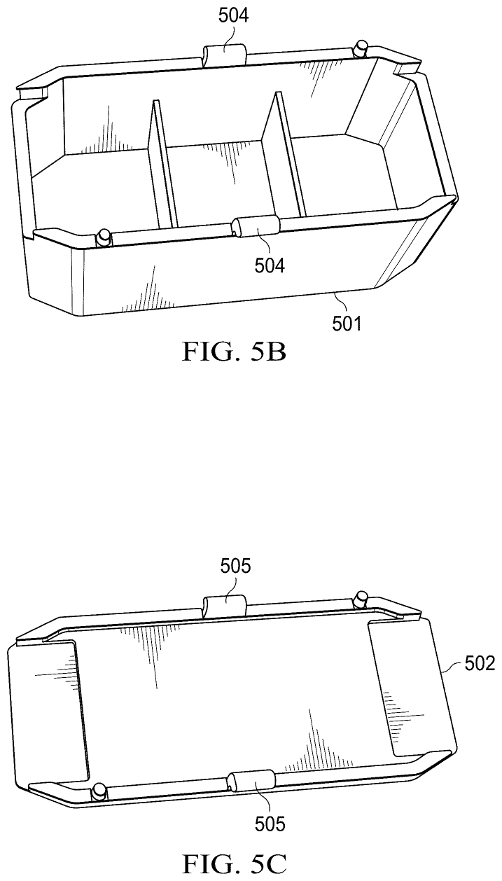

FIG. 5A is a perspective view of a first aspect of a third implementation of an improved tongue 501 positioned on a tongue extension of an edible ink printer 100 having a main structure 101 and carousel mechanism 102. Also seen therein, as discussed herein, is a multi-pronged carousel height extender 900 operable to raise a carousel platter and tray that are positioned on the carousel mechanism 102. Improved tongue 501 is operable to extend out of the main structure 101 of edible ink printer 100, position itself under a cut out of the carousel platter, lift a baked good from the edible ink printer and bring it into the edible ink printer to be printed. Once printed, improved tongue 501 returns the baked good to the carousel printer.

FIG. 5B is a perspective view of first aspect of third implementation of the improved tongue 501 in the inverted position. As can be seen, the first aspect of the inverted improved tongue 501 is a generally cuboid member having tabs 504 that are operable to lock into tongue extension 800.

FIG. 5C is a perspective view of the second aspect of the third implementation of the improved tongue 502. The second aspect of the third implementation of the improved tongue 502 is generally a flat planar member having tabs 505 that are operable to lock into cutouts 801 of tongue extension 800.

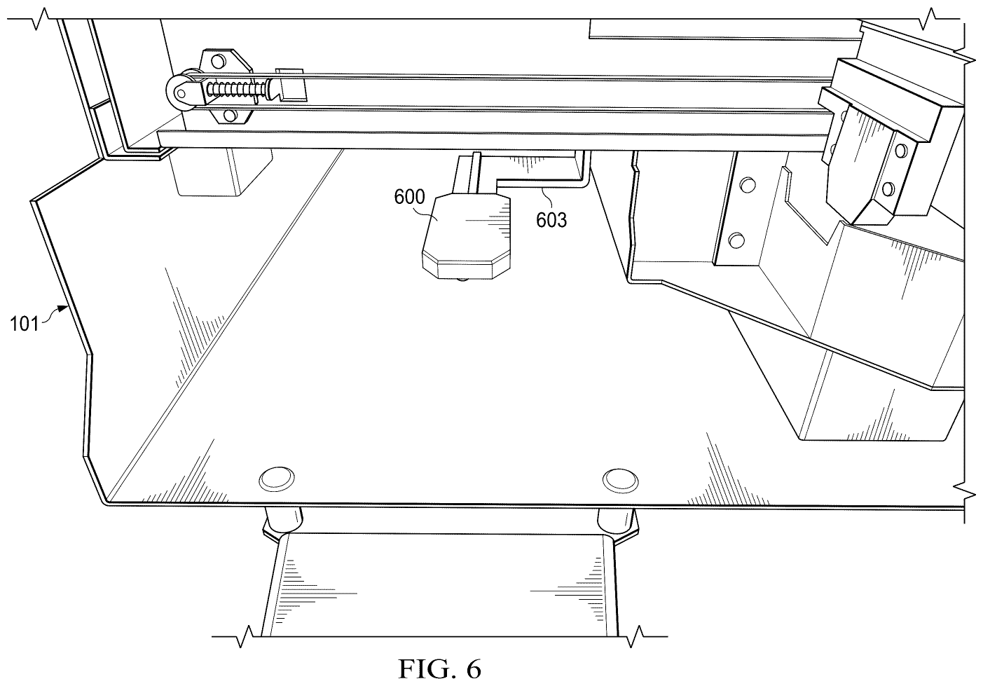

FIG. 6 is a front view of a third aspect of an improved tongue 600 on a differently structured tongue extension for extending the receiving arm within the main structure 101 of the edible ink printer. The tongue 600, having a top side of the planar horizontal surface 601, is extendible by a tongue extension which is coupled to the receiving arm. The tongue 600 on the receiving arm 603 lifts the baked item. The receiving arm 603 retracts into the main housing 101 wherein the edible ink printer head prints a design on the baked item.

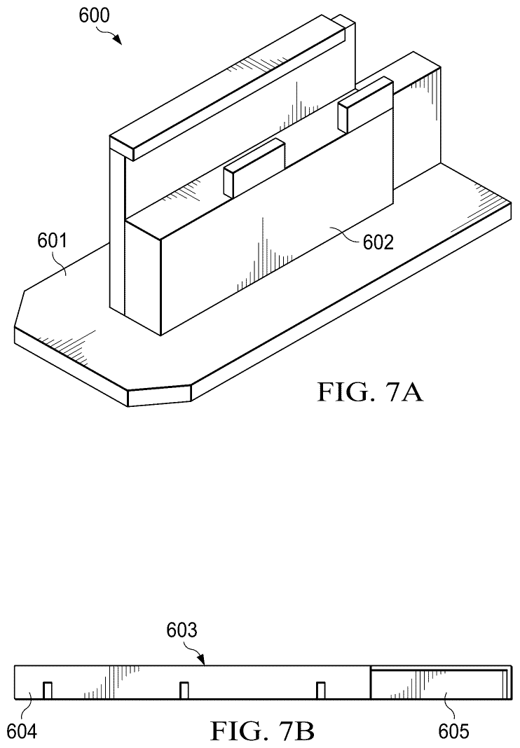

FIG. 7A is a view of the third aspect of the improved tongue 600 being in an inverted position to illustrate how it is structured to be received by a receiving arm or a tongue extension. The improved tongue 600 has planer horizontal surface 601 and a vertical member 602. The planar horizontal surface 601 is orthogonal to the vertical member 602. The orthogonal vertical member 602 has a crosswise length and vertical height, the vertical height being more or less than that found on a stock edible ink printer tongue in an aspect.

FIG. 7B is a view of a tongue extension 603 for extending the receiving arm of the edible ink printer for use with the third aspect of the improved tongue. The distal end 604 of the tongue extension 603 is coupled to a receiving arm of the edible ink printer. The proximate end 605 of the tongue extension 603 is coupled to the improved tongue 600 by, inter alia, snapping in the vertical member 602 of improved tongue 600 into the proximate end 605 of the tongue extension 603 using tabs. The improved tongue extension 603 is operable to extend the improved tongue beyond the distance provided by a stock tongue extension on an edible ink printer.

FIG. 8A is a view of a tongue extension 800 for extending the receiving arm of the edible ink printer for use with the second aspect of the improved tongue. The distal end 801 of the tongue extension 800 is coupled to a receiving arm of the edible ink printer using a plurality of screws through apertures 803. The proximate end 804 of the tongue extension 800 includes tab apertures 805 for coupling the tongue 501/502 as seen in FIG. 5B/5C using the tabs 504/505. The improved tongue 501/502 is configured to be disposed in corresponding tongue extension 800 as seen in FIG. 8, for receiving the improved tongue 501/502. The improved tongue extension 800 is operable to extend the improved tongue beyond the distance provided by a stock tongue extension on an edible ink printer. FIG. 8B the first aspect of third implementation of the improved tongue 501 positioned on the second aspect of the tongue extension 800.

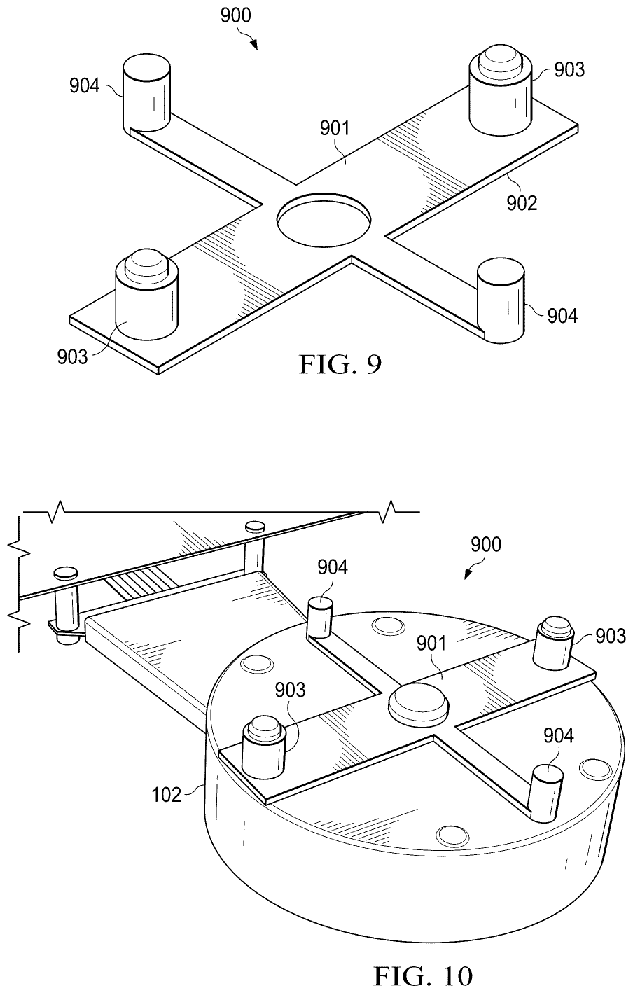

FIG. 9 is a view of a fifth implementation of the invention comprising a multi-pronged carousel height extender 900. The multi-pronged carousel height extender 900 is configured to be positioned between the edible ink printer motor base and the carousel platter, the multi-pronged carousel height extender 900 preferably has a planar upper surface 901 and lower planar surface 902 in a cross shape with two (2) vertical prongs 903 extending from the planar upper surface 901 operable to receive apertures in a carousel platter and two (2) vertical prongs 904 extending from the planar upper surface 901 on which the bottom surface of a carousel platter rests.

FIG. 10 is a view of the multi-pronged carousel height extender 900 positioned on a carousel mechanism 102 adjacent to the main housing of an edible ink printer 100. The multi-pronged carousel height extender 900 is in a cross shape with two (2) vertical prongs 903 extending from the planar upper surface 901 operable to receive apertures in a carousel platter and two (2) vertical prongs 904 extending from the planar upper surface 901 on which the bottom surface of a carousel platter rests. Multi-pronged carousel height extender 900 is configured to be positioned on a carousel mechanism 102 next to an edible ink printer wherein the improved tongue 502 on tongue extension 800 can reach a carousel platter on which edible baked goods are made available to be lifted from the carousel platter and retracted into the edible ink printer for printing.

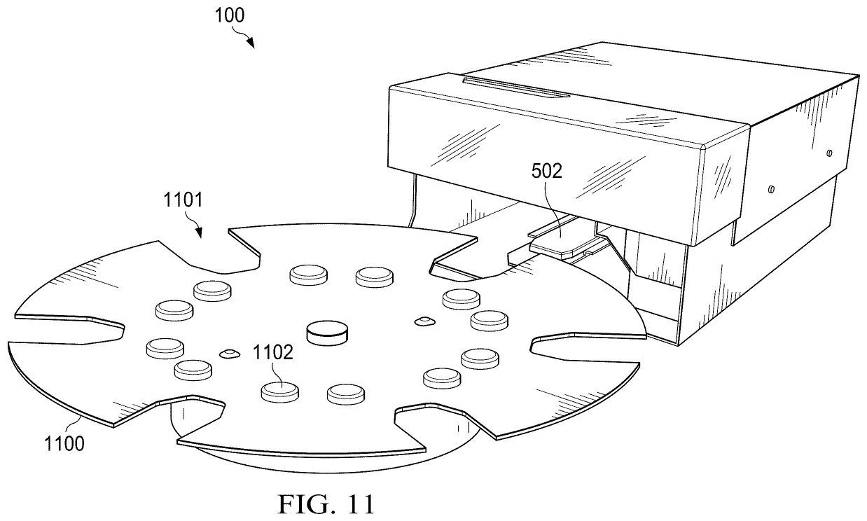

Referring to FIG. 11, a view of a second embodiment being a sixth implementation of the invention comprised of an improved carousel platter 1100 having 6 tongue slots 1101 and carousel platter pegs 1102 is provided.

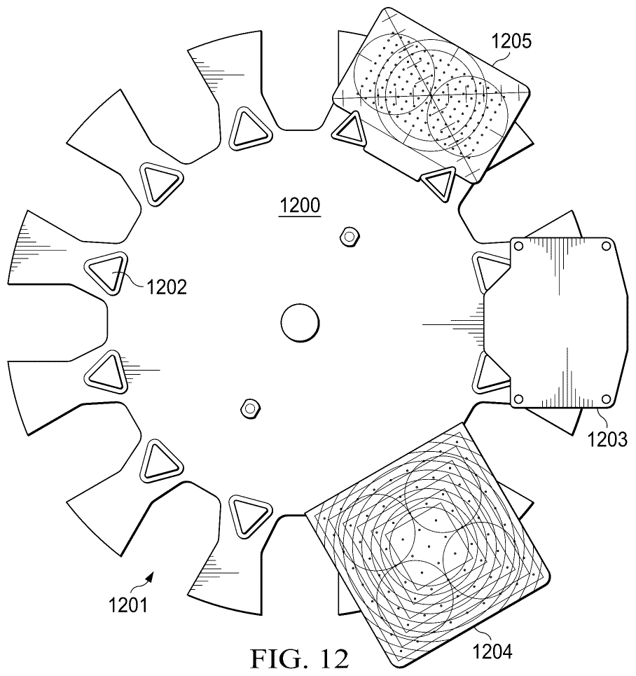

Referring to FIG. 12, there is provided a view of a second embodiment being a seventh implementation of the invention comprised of another improved carousel platter 1200 having 12 tongue slots 1201, a plurality of shorter carousel platter pegs 1202 and including three different trays 1203, 1204, 1205 thereon. Improved carousel platter 1200 that allows for printing of items that are larger and thicker with the described height kit invention than allowed by a stock edible ink printer, e.g., up to 4.724″×4.724″×½″, and 4.724″×4.724″×1.75″ with the enclosed height kit due to the height of the carousel platter pegs 1202. As seen therein, carousel platter pegs 1202 are triangular cuboid shape and are dimensioned to be received in apertures in the carousel platter 1200. A conventional platter limits the size to 4.724″×3.5″×¾″ due to the height of the stock alignment pegs.

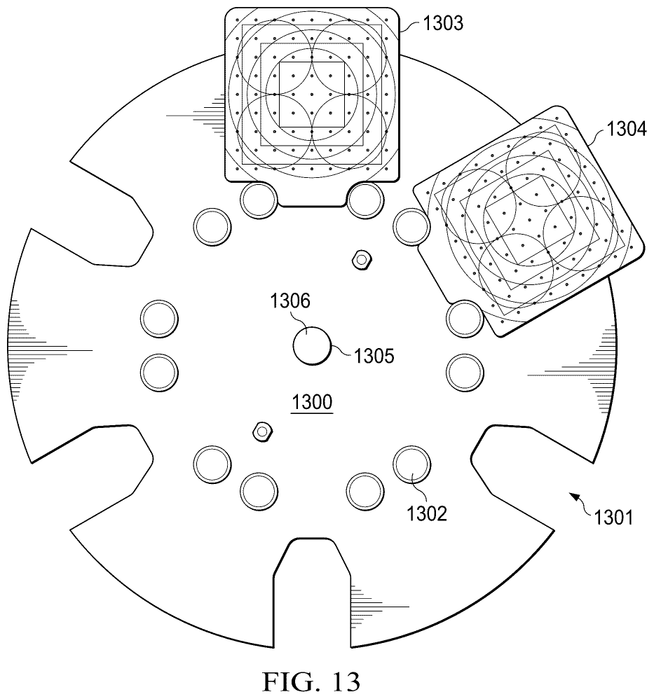

FIG. 13 provides another view of the second embodiment being a sixth implementation of the invention comprised of the improved carousel platter 1300 having 6 tongue slots 1301, a plurality of carousel pegs 1302 and including two different trays 1303, 1304 thereon. With carousel platter 1300, the carousel pegs 1302 are located further back in a circumference near the center aperture 1305. There are 6 open tongue slots 1301 which are dimensioned to receive a tongue for lifting, retracting and printing on items that are up to 4.724″×4.724×¾″ thick. Center aperture 1305 receives carousel motor spindle as seen as 1306. With the improved carousel platter 1300 and the implementations of the first embodiment of the invention, a user can print on items 4.724″×4.724″×2″ thick without trays.

Further referring to FIG. 13, more accurate printing can be accomplished using the carousel platter 1300 coupled with one or a plurality of improved SXL trays 1303. The SXL tray 1303 is dimensioned to be positioned on carousel platter 1300. This is not possible with the conventional carousel platter due to peg placement. Hence, the SXL tray 1303 is dimensioned to be positioned on a carousel platter 1300 with shorter pegs 1302. This allows for printing larger baked goods contrasted with that which can be printed using a conventional platter. The trays are covered by U.S. Regular application Ser. No. 17/848,511 titled FOOD POSITIONING TRAY ACCESSORY FOR EDIBLE INK PRINTING DEVICE, filed Jun. 24, 2022. Such trays can also be used to hold candies such as M&Ms®, Mentos® and fondant.

The location of pegs 1202/1302 as shown FIGS. 12 and 13 was to remove the obstacles of the original peg location and open up the platter to hold larger and thicker items for printing. In a further aspect, the invention further comprises the use of round pegs which are more stable over conventional pegs. These are positioned so as not to interfere with the larger items to be printed.

Furthermore, the pegs are moved back and further apart over the conventional placement so as to remove the obstacles and open up the platter to hold larger items for printing.

The invention further comprises a method to allow the printing of edible ink on thick baked goods positioned on a tray and using a conventional edible ink printer, comprising the steps of:
placing component 1×4 feet, positioned in place over 4 existing feet on an edible ink printer and operable to raise the printer up above the carousel to allow for thicker printing of items;
placing component 2 pegs in place of existing pegs, where the carousel connects to printer on an edible ink printer and operable to connect the carousel to the printer so it is rigid and stays in place;
placing a tongue extension component in place of existing cookie platform adapter to allow the installation of a tongue;
placing a tongue having different height platforms to allow for printing of different heights wherein the baked goods have a thickness of between 0.02″ and 2″, positioned on an edible ink printer and
placing a carousel height component on top of the carousel motor to raise the carousel platter to allow for printing of thinner items of between 0.02″ and 1″.

The invention further comprises a plurality of components operable to allow the printing of edible ink on thick baked goods positioned on a tray and using a conventional edible ink printer.

The invention comprises an improved edible ink printer, having a plurality of cylindrical feet extensions, each cylindrical foot positioned underneath an edible ink printer; a plurality of carousel connecting pegs configured to interpose additional space between a main structure of the edible ink printer and a rotating carousel of the edible ink printer; at least one tongue extension for extending the reach of a tongue in the edible ink printer; a tongue configured to be received on the tongue extension, and a multi-pronged carousel height extender configured to be positioned an edible ink printer motor base and an edible ink printer carousel.

The invention further comprises four (4) cylindrical feet extensions, each cylindrical foot positioned underneath an edible ink printer; and two (2) carousel connecting pegs configured to interpose additional space between a main structure of the edible ink printer and a rotating carousel of the edible ink printer.

The tongue comprises a horizontal plane member onto which an edible food product is positioned and an orthogonal vertical member having a crosswise length and vertical height, the vertical height being less than that found on a conventional tongue of an edible ink printer.

The improved edible ink printer further comprises four (4) cylindrical feet extensions, each cylindrical foot extension positioned underneath an edible printer, over the existing feet of the edible printer.

The invention further is a height accessory kit for an edible ink printer, having a plurality of cylindrical feet extensions, each cylindrical foot positioned underneath an existing foot of an edible ink printer; a plurality of carousel connecting pegs configured to interpose additional space between a main structure of the edible ink printer and a rotating carousel of the edible ink printer; at least one tongue extension for extending the reach of a tongue in the edible ink printer; a tongue configured to be received on the tongue extension, and a multi-pronged carousel height extender configured to be positioned an edible ink printer motor base and an edible ink printer carousel. The foregoing invention are components that are alone or in combination with a main structure of an edible ink printer and an edible ink printer carousel.

The improved carousel platter of the invention has a plurality of tongue slots; a plurality of carousel pegs traversing the improved carousel platter; and a plurality of improved trays to be received on the improved carousel platter and retained in position thereon by the plurality of carousel pegs. The invention further is a height accessory kit for an edible ink printer wherein the carousel pegs are located circumferentially nearer a center aperture for receiving a spindle of the improved carousel platter than that of a conventional edible ink printer. The tongue slots further comprise 6 tongue slots dimensioned to receive a tongue for lifting, retracting and printing on edible items. The invention further includes improved trays positioned on the carousel platter to enable more accurate printing than can be accomplished using a conventional carousel platter

The invention that is a height accessory kit for an edible ink printer further has four (4) cylindrical feet extensions, each cylindrical foot positioned underneath an existing foot of an edible ink printer; and two (2) carousel connecting pegs configured to interpose additional space between a main structure of the edible ink printer and a rotating carousel of the edible ink printer.

The invention that is a height accessory kit for an edible ink printer further comprises a carousel height component positioned on top of the edible ink carousel motor to raise the carousel platter to allow for printing of edible items. In each of the foregoing embodiments and aspects, the cylindrical feet extensions have a height in the range of between 0.95″ and 1.5″. the carousel connecting pegs are in the height range of between 0.65″ and 1.5″ and the height in the range of the tongue is in the range of 20″ and 1.5″.

The invention further is a method to allow the printing of edible ink on thick baked goods positioned on a tray and using a conventional edible ink printer, comprising the steps of: positioning 4 feet extensions over 4 existing feet on an edible ink printer so as to raise the edible ink printer up above the edible ink printer carousel to allow for thicker printing of edible items; installing 2 improved pegs that couple a main structure of the edible ink printer to a carousel motor of the edible ink printer in place of existing pegs, where the improved pegs are operable to rigidly couple the edible ink printer carousel motor to the main structure of the edible ink printer so it remains rigidly in place.

The method of the invention further includes placing a tongue extension in place of existing cookie platform adapter to allow the installation of a tongue; and placing a tongue having different height platforms to allow for printing of edible items having different heights

The method of the invention further comprises placing a carousel height component on top of the edible ink carousel motor to raise the carousel platter to allow for printing of edible items. The method of the invention further includes placing a carousel platter on the carousel height component and further positioning on the carousel platter an improved tray.

The embodiments shown and described above are only exemplary. Even though numerous characteristics and advantages of the invention have been set forth in the foregoing description, the disclosure is illustrative only and changes may be made within the principles of the invention to the full extent indicated by the broad general meaning of the terms used herein. Various alterations, modifications and substitutions can be made to the disclosed invention and the system that implements the invention without departing in any way from the spirit and scope of the invention.

What I claim is:

1. An improved edible ink printer, comprising:
a plurality of cylindrical feet extensions, each cylindrical foot positioned underneath an edible ink printer;
a plurality of carousel connecting pegs configured to interpose additional space between a main structure of the edible ink printer and a rotating carousel of the edible ink printer;
at least one tongue extension for extending the reach of a tongue in the edible ink printer;
a tongue configured to be received on the tongue extension, and
a multi-pronged carousel height extender configured to be positioned an edible ink printer motor base and an edible ink printer carousel.

2. The improved edible ink printer of claim 1, further comprising:
four (4) cylindrical feet extensions, each cylindrical foot positioned underneath an edible ink printer; and
two (2) carousel connecting pegs configured to interpose additional space between a main structure of the edible ink printer and a rotating carousel of the edible ink printer.

3. The improved edible ink printer of claim 1, wherein the tongue comprises a horizontal plane member onto which an edible food product is positioned and an orthogonal vertical member having a crosswise length and vertical height, the vertical height being more or less than that found on a conventional tongue of an edible ink printer.

4. The improved edible ink printer of claim 1, wherein the plurality of feet extensions comprise four (4) cylindrical feet extensions, each cylindrical foot extension positioned underneath an edible printer, over the existing feet of the edible printer.

5. A height accessory kit for an edible ink printer, comprising:
a plurality of cylindrical feet extensions, each cylindrical foot positioned underneath an edible ink printer;
a plurality of carousel connecting pegs configured to interpose additional space between a main structure of the edible ink printer and a rotating carousel of the edible ink printer;
at least one tongue extension for extending the reach of a tongue in the edible ink printer;
a tongue configured to be received on the tongue extension, and
a multi-pronged carousel height extender configured to be positioned an edible ink printer motor base and an edible ink printer carousel.

6. The height accessory kit for an edible ink printer of claim 5, in combination with a main structure of an edible ink printer and an edible ink printer carousel.

7. The height accessory kit for an edible ink printer of claim 5, further comprising an improved carousel platter having a plurality of tongue slots;
a plurality of carousel pegs traversing the improved carousel platter; and
a plurality of improved trays to be received on the improved carousel platter and retained in position thereon by the plurality of carousel pegs.

8. The height accessory kit for an edible ink printer of claim 7, wherein the carousel pegs are located circumferentially nearer a center aperture for receiving a spindle of the improved carousel platter than that of a conventional edible ink printer.

9. The height accessory kit for an edible ink printer of claim 7, further comprising 6 tongue slots dimensioned to receive a tongue for lifting, retracting and printing on edible items.

10. The height accessory kit for an edible ink printer of claim 7, wherein the improved trays enable more accurate printing than can be accomplished using a conventional carousel platter.

11. The height accessory kit for an edible ink printer of claim 5, further comprising four (4) cylindrical feet extensions, each cylindrical foot positioned underneath an existing foot of an edible ink printer; and
two (2) carousel connecting pegs configured to interpose additional space between a main structure of the edible ink printer and a rotating carousel of the edible ink printer.

12. The height accessory kit for an edible ink printer of claim 5, further comprising a carousel height component positioned on top of the edible ink carousel motor to raise the carousel platter to allow for printing of edible items.

13. The improved edible ink printer of claim 1, wherein the cylindrical feet extensions have a height in the range of between 0.95″ and 1.5″, the carousel connecting pegs are in the height range of between 0.65″ and 1.5″ and the height in the range of the tongue is in the range of 0.20″ and 1.5″.

14. A method to allow the printing of edible ink on thick baked goods positioned on a tray and using a conventional edible ink printer, comprising the steps of:
positioning 4 feet extensions over 4 existing feet on an edible ink printer so as to raise the edible ink printer up above the edible ink printer carousel to allow for thicker printing of edible items; and
installing 2 improved pegs that couple a main structure of the edible ink printer to a carousel motor of the edible ink printer in place of existing pegs, where the improved pegs are operable to rigidly couple the edible ink printer carousel motor to the main structure of the edible ink printer so it remains rigidly in place.

15. The method of claim 14, further comprising;
placing a tongue extension in place of existing cookie platform adapter to allow the installation of a tongue; and
placing a tongue having different height platforms to allow for printing of edible items having different heights.

16. The method of claim 15, further comprising placing a carousel height component on top of the edible ink carousel motor to raise the carousel platter to allow for printing of edible items.

17. The method of claim 16, further comprising placing a carousel platter on the carousel height component and further positioning on the carousel platter an improved tray.
